(19) United States
(12) Patent Application Publication
(10) Pub. No.: US 2025/0087856 A1
(43) Pub. Date: Mar. 13, 2025

(54) METHOD FOR CONTROLLING AN ELECTRIC BATTERY

(71) Applicant: WattAlps, MOIRANS (FR)

(72) Inventors: Matthieu DESBOIS-RENAUDIN, VILLARD-DE-LANS (FR); Baptiste HANSER, GRENOBLE (FR); Sylvain BASSET, LA BUISSE (FR)

(21) Appl. No.: 18/728,101

(22) PCT Filed: Jan. 17, 2023
(86) PCT No.: PCT/EP2023/051022

§ 371 Date: Jul. 11, 2024

(30) Foreign Application Priority Data
Jan. 19, 2022 (FR) 2200439

(51) Int. Cl. H01M 50/583; H01M 10/42; H02J 7/00

(52) U.S. Cl. CPC H01M 50/583; H01M 10/425; H02J 7/0029; H02J 7/0047; H01M 2010/4271; H01M 2200/103; H02J 7/0013

(57) ABSTRACT

The invention relates to a method for controlling an electric battery provided with a battery management system, the electric battery comprising at least two branches connected in parallel, each branch comprising at least one energy storage module, the branches being electrically connected to a junction box through which the current of the battery passes, each branch being provided with at least one protection fuse which is suitable for interrupting the passage of an electric current in the event of a current surge in said branch. The method comprises: —determining the absence or presence of a branch current and the absence or presence of a junction current; —checking coherence between the branch current and the junction current, an anomaly of the fuse on said branch being taken into consideration in the event of incoherence; —modifying the operation of the battery management system on the basis of the fuse anomaly, with the other branch providing current.

### FIELD OF THE INVENTION

This invention relates to a method for controlling an electric battery comprising at least two branches connected in parallel, each branch comprising at least one energy storage module, and preferably at least two series-connected energy storage modules, each branch being equipped with at least one protection fuse, the method making it possible to detect a fuse anomaly and to modify the operation of a battery managing system as a function of the anomaly of the fuse.

### PRIOR ART

Electric batteries are used to store electric energy in chemical form and to deliver it in the form of direct current, in a controlled manner. To attain the high powers required for applications such as vehicle mobility, electric batteries are formed of assemblies of electro-chemical accumulator components designed in the form of a cell. These elements have a fairly low nominal voltage, typically 3.7 V, and are electrically connected in series and/or in parallel to achieve levels of voltage and energy compatible with the applications in question. To facilitate the assembly and maintenance of large batteries, but also to make these steps safer, a battery is often divided into sub-assemblies, known as modules. These battery modules generally have a non-hazardous voltage (less than 60V), and dimensions and mass allowing for easy handling. These modules can be assembled in series to adapt the desired level of voltage and form a complete battery, thus forming a branch. These branches can then be connected in parallel to increase the onboard level of energy for the battery and therefore achieve enough autonomy for the intended application.

For large batteries, this type of architecture is repeated and branches are put in parallel so as to increase the onboard capacity, as described in patent EP3273567B1. In this example, the two polarities of a branch are connected to a junction box, which contains the safety members. This configuration has the drawback of using several junction boxes and an additional central unit, resulting in costs and an overall volume which are higher, and not very acceptable for onboard applications.

It is therefore preferable to use architectures with modules connected in series to form branches, the branches being themselves parallel to form a module matrix. To guarantee the safety of these installations each branch is equipped with at least one protection fuse suitable for interrupting the passage of an electric current in the event of an overcurrent in said branch. Typically, fuses can be installed at least on the + and − polarities of each branch, so as to protect the parallel connection cables and avoid a general fault in the event of a fault on a single branch.

These battery architectures are much less bulky and expensive, but they have a major drawback: if one of the fuses is blown, there are fewer cells connected to the junction box. At constant power, the current passing through the other cells therefore becomes higher, and can possibly reach potentially hazardous values. For example, with 3 branches of modules connected in parallel, the blowing of a fuse takes out a branch of the electric circuit. There are then 2 branches of modules left to supply or absorb current, i.e. three times less modules. Each remaining branch must therefore supply or absorb 50% more current to compensate for the missing branch. Exceeding the authorized current limit thresholds by 50%, particularly during charging, can damage the cells of the battery and in the long term cause a fire to break out in the battery.

It is therefore necessary to ensure that the modules of the battery are not subjected to excessively high amperages or voltages, even in the case of a blown fuse. The patent application EP3576214 A1 proposes a system for detecting a faulty battery connection by the monitoring of voltage and detection of excessive resistances, by comparing the voltages of the cells to the overall voltage of the battery. This system is very heavily dependent on the measurement accuracies of the sensors of the cell voltages and of the voltage of a full battery. For high-voltage batteries (for example 800V), a measurement error of 1% is already equivalent to twice the maximum voltage of a lithium ion cell.

Moreover, systems such as that proposed by the patent application EP3576214 A1 make provision for cutting the power to the battery in the event of an anomaly being detected. An electric vehicle powered by the battery is therefore out of order in the event of an anomaly. However, the high powers and capacity required for the electrical propulsion of a vehicle incur the need to possess a battery formed of many cells, increasing the risk of anomalies. The battery can then lack reliability in the fulfilment of its function of supplying power to an electric vehicle.

There is therefore a need for a method for controlling an electric battery that makes it possible to provide an electrical power supply to the load powered by the battery, while ensuring that the electrical safety margins of the battery modules are kept, even in the event of an anomaly such as the blowing of a fuse.

### SUMMARY OF THE INVENTION

Provision is made for a method for controlling an electric battery equipped with a battery management system; the electric battery comprising at least two branches connected in parallel, each branch comprising at least one energy storage module, the branches being electrically connected to a junction box through which the battery current passes, each branch being equipped with at least one protection fuse suitable for interrupting the passage of an electric current in the event of an overcurrent in said branch, the method comprising:
the determination of an absence or of a presence of a branch current flowing through a branch, and of an absence or a presence of a junction current equivalent to the accumulated currents flowing through the branches,
a check of the consistency between the absence or the presence of a branch current and the absence or the presence of a junction current, an anomaly of the fuse on said branch being considered in the event of an inconsistency,
a modification of the operation of the battery management system as a function of the anomaly of the fuse, in which the other branch continues to supply current.

The controlling method according to the invention simply detects the absence or the presence of a branch current, and thus does not require any precise or complex measuring device, unlike methods requiring a precise measurement of the current. Moreover, even in the event of a fuse anomaly on a branch, the battery continues to supply electricity.

Advantageously, but optionally, the method may comprise at least one from among the following features, taken alone or in any combination whatsoever:
each branch comprises at least two series-mounted energy storage modules;
the modification of the operation of the battery management system comprises a reduction of a junction current limit;
the reduction of the junction current limit is a function of a factor corresponding to the portion of the branch in the current supply of the battery;
the determination of an absence or of a presence of a branch current flowing through a branch comprises the measurement of the amperage of the branch current using a voltage across the terminals of a conductive part of an energy storage module of said branch, said conductive part forming a portion of a power circuit through which at least a part of the branch current passes;
the voltage across the terminals of a conductive part of a module is determined based on a measurement point from among the measurement points used by an electronics board of the module to determine internal voltages of said modules, and based on another measurement point corresponding to a power connection terminal of the module;
the conductive part of a module is a busbar;
the determination of an absence or of a presence of a branch current flowing through a branch comprises the measurement of the branch current, and the comparison to at least one threshold, the absence or the presence of a branch current being determined as a function of a result of the comparison;
the determination of an absence or of a presence of a branch current flowing through a branch is based on a plurality of current measurements in the branch at different points of said branch, the absence or the presence of a branch current being determined based on a value derived from the plurality of current measurements.

The invention also relates to an electric battery equipped with a battery management system, the electric battery comprising at least two branches connected in parallel, each branch comprising at least one energy storage module or a number of series storage modules, the branches being electrically connected to a junction box through which the battery current passes, each branch being equipped with at least one protection fuse suitable for interrupting the passage of an electric current in the event of an overcurrent in said branch, the battery management system being configured to implement:
the checking of the consistency between the absence or the presence of a branch current and the absence or the presence of a junction current, an anomaly of the fuse on said branch being considered in the event of an inconsistency,
a modification of the operation of the battery management system as a function of the anomaly of the fuse, in which the other branch continues to supply current, in accordance with the method according to the invention.

The invention also relates to an electric propulsion vehicle comprising the electric battery according to the invention.

### DESCRIPTION OF THE FIGURES

Other features, aims and advantages of the invention will become apparent from the following description, which is purely illustrative and non-limiting, and which must be read with reference to the appended drawings wherein:

FIG. 1 schematically illustrates the configuration of a battery powering a machine, in an example with three branches, according to a possible embodiment of the invention;

FIG. 2 shows an example of an energy storage module according to a possible embodiment of the invention;

FIG. 3 illustrates a detail of a front face of a module, showing the busbar connecting two measurement points;

FIG. 4 is a diagram schematically illustrating the steps of the method according to a possible embodiment of the invention.

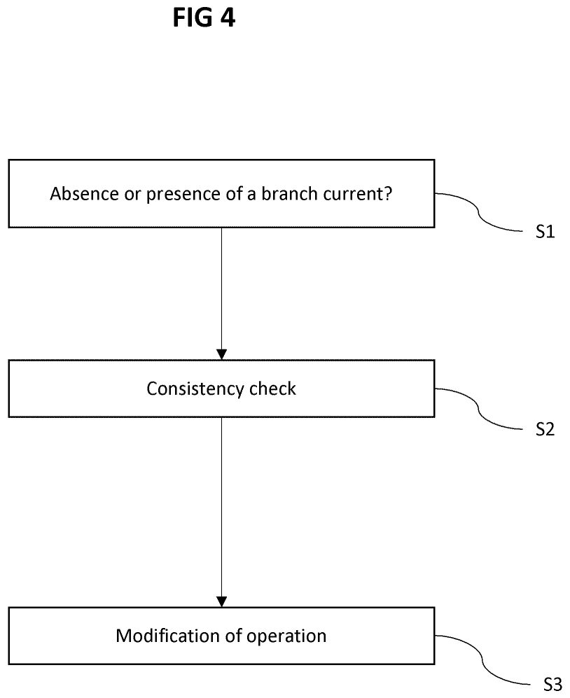

In all the figures, similar components bear identical reference numbers.

### DETAILED DESCRIPTION

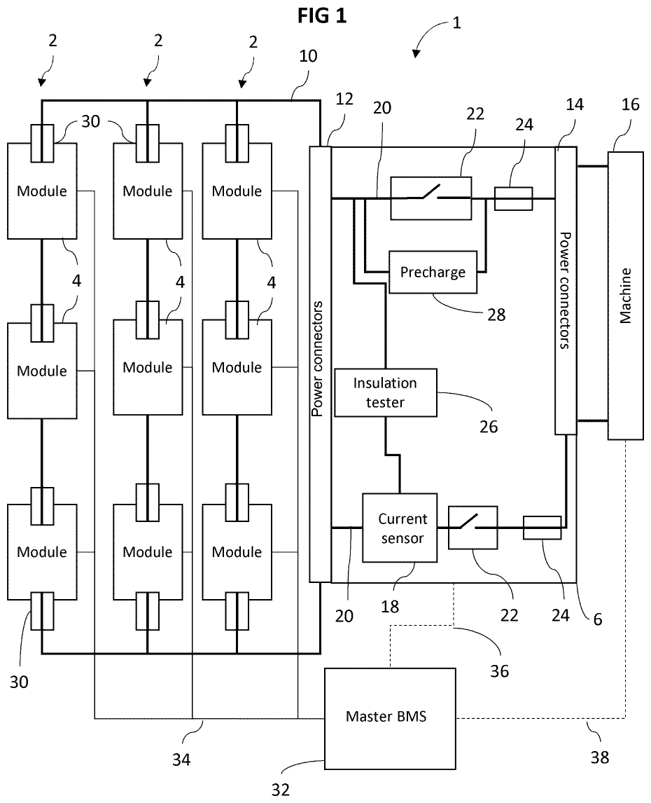

With reference to FIG. 1, an electric battery 1 comprises at least two branches 2 connected in parallel, and in this simplified example comprises three branches 2. Additional branches 2 can be provided depending on the applications in question. Preferably, in order to be able to provide a large capacity for the battery 1, the battery 1 typically comprises over 10 branches 2 in parallel. Each branch 2 comprises at least one energy storage module 4 and preferably several energy storage modules 4 connected in series, such as for example three modules 4 per branch 2 in FIG. 1. Preferably each branch 2 comprises the same number of modules 4. The connecting of branches 2 in parallel makes it possible to increase the power or energy of the electric battery 1.

As explained above, each module 4 is an assembly of electro-chemical accumulators in a unit. Typically, the nominal voltage across the terminals of a module is between 30 V and 100 V, and is for example of 60 V. The series connection of several modules 4 in a branch 2 makes it possible to increase the voltage across the terminals of the branch 2. The patent application FR3089067 describes an example of a module that can be used. A module 4 is generally equipped with management electronics, for example used to measure the temperature or the voltage across the terminals of the module 4.

The branches 2 are electrically connected to a junction box 6 through which the current of the battery 1 passes. More precisely, a power circuit 10 connects the parallel branches 2 to power connectors 12 of the junction box 6. Other power connectors 14 of the junction box 6 are connected to the machine 16 that the battery 1 supplies with electricity, in this example of a discharging configuration of the battery 1. In a charging configuration of the battery, it is of course a power supply that is connected to the power connectors 14 of the junction box, in order to recharge the energy storage modules 4. Preferably, the machine 16 powered by the battery 1 is an electric vehicle, the battery supplying the propulsive electric energy of said vehicle.

The junction box 6 may include components suitable for fulfilling different interface functions of the battery. The junction box 6 may comprise a current sensor 18 on at least one supply line 20, allowing a current measurement on said supply line 20. The term “current measurement” is understood to mean a measurement used to determine the characteristics of an electric current. Typically, a current measurement is a measurement representative of the current amperage, and can be a direct measurement of this amperage, or can be a measurement of a voltage proportional to the amperage of this current.

As in the illustrated example, the junction box 6 may comprise switches 22, where applicable series-coupled with fuses 24, for example on each of the two supply lines 20. The junction box 6 may comprise an insulation tester 26 between the two supply lines 20, and for example a pre-charging circuit in parallel with a switch 22 on one supply line 20.

Each branch 2 is equipped with at least one protection fuse 30 suitable for interrupting the passage of an electrical current in the event of an overcurrent in said branch 2. Preferably, each branch 2 comprises at least one fuse 30 at each end of said branch 2. Typically, and as illustrated, one fuse 30 can be associated with each module 4 of the branch 2.

The battery 1 is equipped with a battery management system (BMS). The BMS is referred to as “master” to distinguish it from other BMS that can be associated with each module 2, referred to as the “slave” BMS since it is subordinate to the master BMS. These BMS of modules 4 are the management circuits mentioned above. Subsequently, the term “BMS” refers to the master BMS. The BMS 32 is connected to each of the modules 4 by communication channels 34 over which signals such as measurements or commands travel. The BMS 32 is also connected to the junction box 6 by communication channels 36 over which signals such as measurements or commands travel. The BMS 32 can also be connected to the machine 16 by a communication channel 38, serving as communication interface between the battery 1 and the machine 16. The BMS 32 is a control member comprising a processor and a memory, and which is capable of communicating.

Each branch 2 is equipped with at least one current sensor, allowing a measurement of the branch current on said branch, i.e. the current flowing from one end of the branch 2 to the other. Typically, a current sensor is integrated into the module 4. Preferably, each module 4 is equipped with such a current sensor, in order to standardize the modules. However, only a single current measurement per branch 4 is required. The current sensor measures a voltage across the terminals of a conductive part of an energy storage module 4, this voltage being representative of the amperage of the branch current flowing through the branch 2 of the battery 1. Preferably, the conductive part of the energy storage module 4 across the terminals of which the voltage is measured comprises a portion of a power circuit through which all or part of the current of the branch passes. Preferably, at least 50%, and still preferably at least 75% of the branch current passes through the portion of a power circuit across the terminals of which the voltage is measured. Such a portion of a power circuit typically has a resistance greater than 150 microohms, and preferably greater than 300 μΩ. Preferably, this portion of the power circuit is a busbar, i.e. a conductor connecting several electric circuits at separate points, in this case connecting several modules 4 to one another.

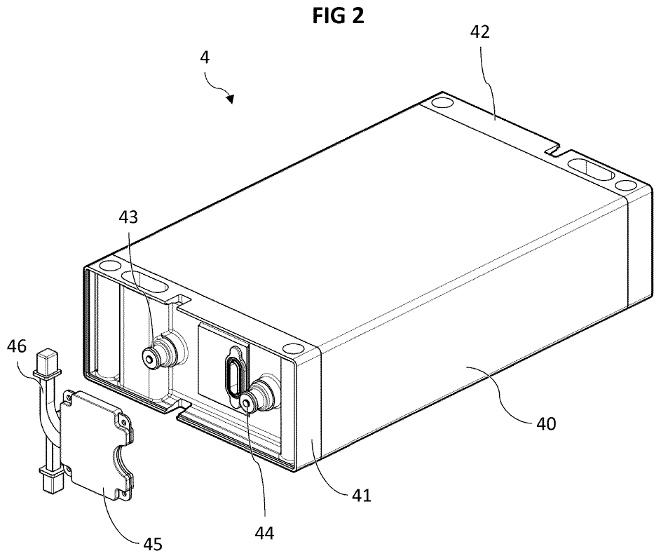

With reference to FIG. 2, each module 4 comprises a casing, or box, comprising a plurality of walls, typically a unit 40 having a substantially parallelepipedal shape and two cowls 41, 42 hermetically sealing the unit 40, together defining a sealed enclosure. The term “sealed” is here understood to mean a seal against any type of fluid element, such as water and/or air, or from the inside to the outside of the enclosure. An assembly of cells is arranged within the enclosure, each cell comprising an electrochemical accumulator. Such electric batteries have, for example, been described in the patent application WO 2020/109714.

Each module 4 comprises connection terminals 43, 44 configured to be coupled to power connectors connecting the modules 4 to one another, particularly to series-connect modules 4 of one and the same branch 2. More precisely, each module 4 comprises a first terminal 43, which for example corresponds to the negative terminal “−”, and a second terminal 44, which for example corresponds to the negative terminal “+”. When the modules 4 are series-connected, the first terminal 43 of a module 4 is connected to the second terminal 44 of a previous module 4, and the second terminal 44 of said module 4 is connected to the first terminal 43 of a following module 4. The modules 4 at the ends of a branch 2 have a terminal 43, 44 connected to a power circuit 10. Typically, these connection terminals 43, 44 protrude from a cowl 41 referred to as forming the front face.

To be able to measure at least one from among the voltage delivered by each cell or group of cells and the temperature of each cell or group of cells, several sensors are arranged inside the unit 40. Each sensor is configured to emit a signal, preferably electrical, as a function of voltage and/or temperature values recorded at one or more cells. This signal must then be processed outside the enclosure.

With reference to FIG. 1, for the purpose of making this signal emitted by the sensor travel from the inside to the outside of the enclosure, an electronics board 45 is advantageously added on an outer surface of a wall of the unit 40, preferably a wall of one of the two cowls 41, 42, as can be seen on FIG. 1. As can be seen on FIG. 1, connectors 46, preferably of electrical type, are advantageously connected to the electronics board 45, so as to make a signal travel from the electronics board 45 to another component of the electric battery, typically the battery management system 32. Another connector, not shown, typically connects the electronics board 45 with the inside of the unit 40, and in particular the internal sensors. The electronics board 45 with the inside of the box 40, and particularly the internal sensors. The electronics board 45 is equipped with processing means such as an electronic chip, such as for example the chip MAX17852 or MAX17853 from Maxim Integrated or the chip MC33771 from NXP, which are specifically developed for the monitoring of the battery.

As explained previously, internal sensors are configured to measure voltages between assemblies of cells. These voltage measurements are taken between measurement points at different potentials, representative of the gradual rise in voltage in the assembly of cells of the module 4. The plurality of voltage measurements resulting therefrom are used, in particular, to check that the voltage across the terminals of each cell or group of cells remains within the ranges of values not damaging the cells. This is because, due to the electro-chemical nature of the cells, an excessively low voltage can cause problems, particularly on recharging, while an excessively high voltage causes a fire risk.

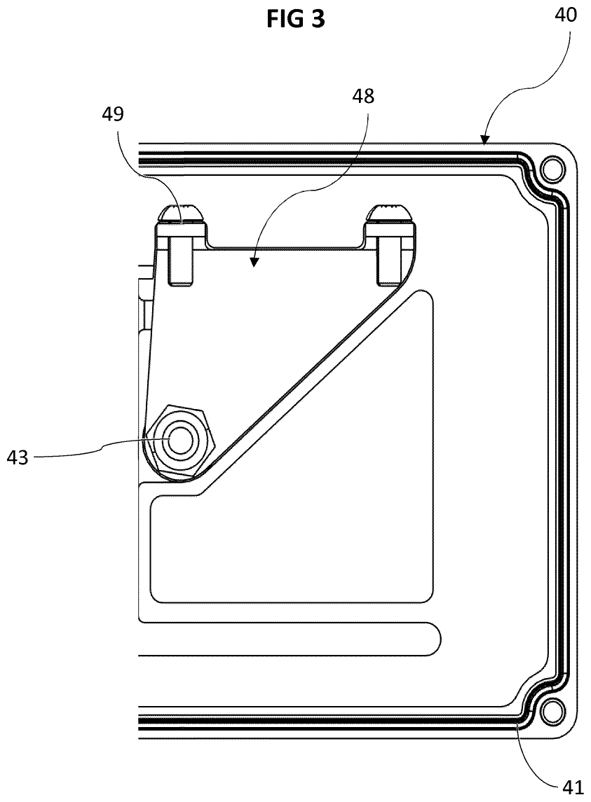

Out of the measurements points of a module 4, one measurement point corresponds to an extreme voltage, i.e. the smallest or largest potential out of those used by the sensors, and which corresponds to the measurement at one extremity of the cell assembly. With reference to FIG. 3, this extremity of the cell assembly is electrically connected by a conductive part to a connection terminal 43, 44 forming the power connection at the module output 4. The current of the module 4, and therefore of the branch 2 to which said module 4 belongs, flows through this conductive part, which thus forms a portion of the power circuit and generally takes the form of a busbar 48.

In the illustrated example, the fastener 49 of the busbar 48, in the form of a screw, is the first measurement point with the lowest potential. A wire attached to the fastener 49 for example can be used to mark the lowest potential. The busbar 48 connects this measurement point to the second connection terminal 43. This connection terminal 43 forms the second measurement point, used to record a potential which is slightly different from that of the first measurement point. The difference between the potentials comes from the branch current flowing through the busbar 48. The voltage measurement based on these two measurement points is therefore representative of the amperage of the branch current.

Such an approach enables the use of a measurement point from among those already used for monitoring the voltage in the module 4. The second measurement point is preferably a connection terminal 43, 44, which is both easily accessible and separated by a conductive part from the module 4 forming a portion of the power circuit.

The first measurement point and the second measurement point can be connected to the external electronics board 45, which can deduce potential differences, even small, between the two measurement points, and deduce a current measurement therefrom. It is also possible to make use of two voltage measurements, one involving the first measurement point and the other involving the second measurement point (for example with respect to a common reference), and to determine, as a voltage measurement representative of the branch current, a difference between these voltage measurements. It is possible to use an operational amplifier to record measurements such as for example that existing in the circuits MAX17852 from Maxim Integrated or MC33771 from NXP.

Unlike systems of the prior art, the measurement of the current is not done across the terminals of a calibrated precision resistance, of only a few μΩ, series-connected with the whole circuit, needing to have a branch bottom module different from the other modules. Conventionally, this precision (or “shunt”) resistance is made of a particular material so as to keep its resistance value under all conditions, for example made of copper-magnesium-nickel. Such current measurements of the prior art must specifically be precise for applications such as a precise estimate of the state of charge of the battery 1, which is computed by integration and therefore requires a high degree of precision.

In this invention, it is not necessary for the measurement of the branch current to be very precise, since it only aims to detect the presence or the absence of flow of a branch current, as described in the method hereinafter.

The method is intended to be implemented by continuous iteration. With reference to FIG. 3 during a first step S1, an absence or a presence of a branch current flowing through a branch 2 is determined. The determination of the absence or the presence of a branch current flowing through the branch 2 can typically comprise the measurement of the amperage of the branch current using a sensor measuring a voltage across the terminals of a conductive part of an energy storage module 4 of said branch 2, as explained above. Typically, such a current measurement is then compared to a threshold, and the absence or the presence of a branch current is determined as a function of a result of the comparison.

For example, it is possible to compare the current measurement to a charge threshold representative of a charging current, for example greater than 250 mA if the measurement is an amperage measurement, or greater than 62.5 mV if the measurement is a voltage measurement. If the current measurement is greater than this charge threshold, this means that a charging current is flowing through the branch 2. If the current measurement is less than this charge threshold, this means either that no branch current is flowing, or that a discharge current is flowing. It is therefore possible to compare the current measurement to a discharge threshold representative of a discharge current, for example less than −250 mA if the measurement is an amperage measurement, or less than −62.5 mV if the measurement is a voltage measurement. If the current measurement is less than this charge threshold, this means that a discharge current is flowing through the branch 2. If the current measurement is greater than this discharge threshold, this means either that no branch current is flowing, or that a charge current is flowing. A presence or an absence of flow of a branch current is thus determined if the current measurement is between the charge threshold and the discharge threshold. As a simplification, it is possible to compare an absolute value of the current measurement to a threshold current, below which an absence of current in the branch 2 is determined.

It is possible for several current measurements to be available, particularly when several current sensors are available on the same branch 2, at different points on the branch, for example with one current sensor per electricity storage module 4. In this case, the absence or the presence of a branch current is determined based on a value derived from the plurality of current measurements. Typically, an average of the current measurements can be determined, and it is this average which is used as the current measurement during the comparison to at least one threshold.

The simple determination of an absence or of a presence of a branch current flowing through a branch is not enough to determine an anomaly of the fuse 30 on this branch 2, such as a blowing of the fuse 30. The absence of branch current can also be normal in the absence of any power being exchanged between the battery 1 and the machine 16 to which said battery 1 is connected (for example a vehicle or a supply). It is therefore necessary to check the consistency between the absence or the presence of a branch current and the absence or the presence of a junction current flowing through the junction box 6 and equivalent to the accumulated currents flowing through the branches 2. To do this, an absence or a presence of the junction current is determined, for example by means of the current sensor 18 present in the junction box. In a similar way to the branch current, the current measurement is compared to a threshold, and the absence or the presence of a junction current is determined according to a result of the comparison.

The consistency between the absence or the presence of a branch current and the absence or the presence of a junction current means that an absence of a branch current must have a corresponding absence of a junction current, and conversely, that a presence of a branch current must have a corresponding presence of a junction current. In the event of an inconsistency, particularly in the case of an absence of a branch current and a presence of a junction current, it is considered that the fuse 30 on said branch has an anomaly. An anomaly of the fuse 30 is typically the fact that the fuse 30 is blown, for example following a current of excessive amperage on the branch 2. It is possible for the absence or the presence of a branch current, just like the absence or the presence of a junction current, to each be expressed by an indicator, for example a high value or low value of a voltage, or even by a digital value. In this case, the comparison simply equates to comparing the indicators, for example digitally or with logic gates.

After determining an anomaly of the fuse 30 on the branch 2, a modification is made to the operation of the battery management system, or BMS 32, as a function of the anomaly of the fuse (step S3), in which the other branch continues to supply current. The modification of the operation of the battery management system 32 takes into account the unavailability of the branch 2 on which the anomaly has been detected without however interrupting the electrical power supply to the machine 16, or the recharging of the battery 1. Preferably, the modification of the operation of the battery management system 32 comprises a reduction of a junction current limit. This reduction is advantageously a function of a current limit associated with the branch 2 affected by the fuse anomaly. Preferably, the battery management system 32 adapts at least one authorized maximum current threshold as a function of the number of branches 2 unaffected by a fuse anomaly.

Typically, the junction current limit is an item of information transmitted to the machine or vehicle 16, which can thus control the amperage of the current drawn off the battery as a function of this junction current limit. It is also possible to make provision for a safety procedure for the battery if the junction current exceeds the junction current limit, for example because the machine 16 does not take into account the information about the junction current limit. The safety procedure may comprise the disconnection of the battery, for example by tripping at least one switch 22 on a supply line 20, or by putting the battery in a fault condition, with an item of fault information being sent to the machine 16.

By way of example, on FIG. 1, the battery comprises three branches 2 in parallel. The battery management system 32 is configured to limit the maximum current travelling through the junction box, for obvious safety reasons. If the fuse 30 blows on a branch 2, this branch 2 can no longer provide its share of current. The total current must therefore be supplied by the two other remaining branches 2, which therefore end up supplying 50% more current than before, to compensate for the missing branch. This 50% increase in current can exceed the limit authorized for a branch 2, and lead to the deterioration of the battery, or even cause a fire to break out in the battery 1. Of course, the effect of the unavailability of a branch is less critical when the branches 2 are numerous. For example, the loss of one branch 2 out of ten branches 2 implies only a 10% increase for the current of the remaining branches 2. However, even a small increase can have consequences, especially as the battery 1 is generally configured to respond to power peaks. Insofar as a safety margin is expressed as an excess capacity in modules 4, and therefore as costs, weight and bulk, it is preferable to keep this margin as low as possible. Thus, even a single minor transfer of current to the remaining branches 2 can be enough to overuse the remaining modules of the branches.

Thus, according to the invention, by detecting the fuse anomaly 30, an authorized current threshold is reduced in proportion to the portion of the branch 2 affected in the distribution of the currents. Let us call V₁ the maximum authorized junction current when all the branches 2 are connected and deliver current. In the presence of n identical branches (n>2) in operation, the detection of a fuse anomaly on a branch causes a reduction of the maximum junction current threshold V₁ by a factor (n−1)/n. With two preferably similar branches, the current limit will thus be reduced by one third for three branches 2, and by 10% for ten branches 2. The remaining branches 2 are therefore not subjected to a higher maximum use than before. It is however possible to use other reduction factors, for example allowing a reduction in the safety margins, assuming that the anomaly is not of a persistent nature, and that replacement of the fuse 30 will happen quickly.

The proposed method does not therefore make provision for the stopping of the battery 1, but instead makes provision for a failsafe operation mode, in which the authorized maximum power is reduced, via a reduction of the authorized maximum for the junction current. The method is therefore specially suited to the supply of electricity to an electric vehicle, which does not tolerate any interruption in the power supply. It should be noted that the examples below mention only one blowing of a fuse 30 affecting a branch 2, and it is possible for several successive branches to be affected. In this case, the method is reiterated and detects each fuse anomaly 30, causing a successive adaption of the operation of the battery management system 32. The method is therefore suitable for responding to the occurrence of several successive fuse 30 blowings, increasing the fitness of the battery 1 to supply power despite multiple failures. Of course, if there are no more available branches 2, the battery 1 is stopped. It is possible to make provision for the BMS to send an item of information about the detected fuse 30 anomaly to the machine 16, preferably identifying the branch 2 affected by the anomaly.

The invention is not limited to the embodiment described and shown in the appended figures. Modifications remain possible, particularly from the point of view of the composition of the various technical features or by substitution of technical equivalents, without however departing from the scope of the invention.

1. A method for controlling an electric battery equipped with a battery management system, the electric battery comprising at least two branches connected in parallel, each branch comprising at least one energy storage module, the branches being electrically connected to a junction box through which the battery current passes, each branch being equipped with at least one protection fuse suitable for interrupting the passage of an electric current in the event of an overcurrent in said branch,
the method comprising:
determining an absence or a presence of a branch current flowing through a branch, and an absence or a presence of a junction current equivalent to the accumulated currents flowing through the branches,
checking the consistency between the absence or the presence of a branch current and the absence or the presence of a junction current, an anomaly of the fuse on said branch being considered in the event of an inconsistency,
modifying the operation of the battery management system as a function of the anomaly of the fuse, in which the other branch continues to supply current.

2. The method as claimed in claim 1, wherein the modification of the operation of the battery management system comprises a reduction of a junction current limit.

3. The method as claimed in claim 2, wherein the reduction of the junction current limit is a function of a factor corresponding to the portion of the branch in the current supply of the battery.

4. The method as claimed in claim 1, wherein determining an absence or a presence of a branch current flowing through a branch comprises measuring the amperage of the branch current using a voltage across the terminals of a conductive part of an energy storage module of said branch, said conductive part forming a portion of a power circuit through which at least a part of the branch current passes.

5. The method of claim 4, wherein the voltage across the terminals of a conductive part of a module is determined based on a measurement point from among the measurement points used by an electronics board of the module to determine internal voltages of said modules, and based on another measurement point corresponding to a power connection terminal of the module.

6. The method as claimed in claim 4, wherein the conductive part of a module is a busbar.

7. The method as claimed in claim 1, wherein determining an absence or a presence of a branch current flowing through a branch comprises measuring the branch current, and comparing to at least one threshold, the absence or the presence of a branch current being determined as a function of a result of the comparison.

8. The method as claimed in claim 1, wherein determining an absence or a presence of a branch current flowing through a branch is based on a plurality of current measurements in the branch at different points of said branch, the absence or the presence of a branch current being determined based on a value derived from the plurality of current measurements.

9. An electric battery equipped with a battery management system, the electric battery comprising at least two branches connected in parallel, each branch comprising at least one energy storage module, the branches being electrically connected to a junction box through which the battery current passes, each branch being equipped with at least one protection fuse suitable for interrupting the passage of an electric current in the event of an overcurrent in said branch, the battery management system being configured to implement:
checking the consistency between the absence or the presence of a branch current and the absence or the presence of a junction current, an anomaly of the fuse on said branch being considered in the event of an inconsistency,
modifying the operation of the battery management system as a function of the anomaly of the fuse, in which the other branch continues to supply current, in accordance with the method as claimed in claim 1.

10. An electric propulsion vehicle comprising the electric battery of claim 9.
